(19) United States
(12) Patent Application Publication
(10) Pub. No.: US 2022/0303083 A1
(43) Pub. Date: Sep. 22, 2022

(54) APPARATUS AND METHOD FOR PROVIDING FRAME PREEMPTION

(71) Applicant: ELECTRONICS AND TELECOMMUNICATIONS RESEARCH INSTITUTE, Daejeon (KR)

(72) Inventors: Chang-Ho CHOI, Daejeon (KR); Taesik CHEUNG, Daejeon (KR); Tae Kyu KANG, Daejeon (KR); Jeong-Dong RYOO, Daejeon (KR); Woo Young CHOI, Daejeon (KR)

(73) Assignee: ELECTRONICS AND TELECOMMUNICATIONS RESEARCH INSTITUTE, Daejeon (KR)

(21) Appl. No.: 17/528,521

(22) Filed: Nov. 17, 2021

(30) Foreign Application Priority Data
Mar. 18, 2021 (KR) 10-2021-0035150

(51) Int. Cl. H04L 5/00; H04L 1/00

(52) U.S. Cl. CPC H04L 5/0044; H04L 1/0007; H04W 80/02

(57) ABSTRACT

When a transmitting apparatus wants to transmit a preemptable frame, the transmitting apparatus transmits a preemptable packet by a custom preamble including frame length information on a payload of the preemptable frame to the payload of the preemptable frame. A receiving apparatus determines whether a received preemptable frame is fragmented using frame length information set in the custom preamble of the received preemptable frame. As described above, since it is possible to check whether the received frame is fragmented using the frame length information set in the custom preamble, there is no need to perform CRC calculation to determine whether the received frame is fragmented as in the prior art.

### CROSS-REFERENCE TO RELATED APPLICATION

This application claims priority to and the benefit of Korean Patent Application No. 10-2021-0035150 filed in the Korean Intellectual Property Office on Mar. 18, 2021, the entire contents of which are incorporated herein by reference.

### BACKGROUND OF THE INVENTION

### (a) Field of the Invention

The present invention relates to a method and apparatus for providing frame preemption, and more particularly, to a method and apparatus for providing frame preemption capable of providing a frame preemption function having a simple structure without using a plurality of Media Access Controls (MACs).

### (b) Description of the Related Art

The IEEE 802 Local area network (LAN)/Metro area network (MAN) Standard Committee (LMSC) aims for application of various industrial fields (broadcasting, manufacturing, transportation such as cars, home appliances, energy, etc.) that require time-sensitive traffic processing, and time-sensitive networking (TSN) technology that guarantees time/jitter/delay through Ethernet-based wired/wireless LAN/MAN discussion is in progress, centering on the 802.1 Working Group (WG).

In particular, in order to protect the transmission of a high-priority frame from interference from a low-priority frame, even if the low-priority frame is being transmitted on the link, if there is a request to transmit the high-priority frame, a frame preemption method in which the low-priority frame is transmitted again after stopping transmitting the low-priority frame and transmitting the high-priority frame is defined in the standards (IEEE 802.1Qbu, IEEE 802.3br).

The frame preemption defined in the standard is implemented using an express MAC (eMAC), a preemptable MAC (pMAC), and a MAC merge Sublayer.

However, in the frame preemption method using the MAC merge sublayer, a MAC merge sublayer must be added between the existing general MAC and a reconciliation sublayer (RS), and a plurality of MACs divided into eMAC and pMAC must be used. In addition, since packet fragmentation is performed in the MAC merge sublayer after MAC when transmitting a packet, mCRC calculation for updating the frame check sequence (FCS) field needs to be re-performed, and mCRC calculation must be additionally performed in order to detect the fragmented packet in the MAC merge sublayer before MAC when receiving the packet.

### SUMMARY OF THE INVENTION

The present invention has been made in an effort to provide a method and apparatus for providing frame preemption that can provide a frame preemption function more simply while using a single MAC.

According to an embodiment, a method for providing a frame preemption in a transmitting apparatus is provided. The method for providing a frame preemption includes: when a frame to be transmitted is a preemptable frame, setting a first custom preamble including frame length information for a payload of the preemptable frame; and transmitting a preemptable packet by adding the first custom preamble to the payload of the preemptable frame through a media access control (MAC) layer.

The frame length information may be used to distinguish whether the preemptable frame received by a receiving apparatus is in a fragmented state by the frame preemption of the transmitting apparatus.

The method for providing a frame preemption may further include: fragmenting the preemptable frame being transmitted and then stopping transmission of the preemptable frame if preemption is determined by the request for transmission of the express frame before the transmission of the preemptable frame is completed.

The method for providing a frame preemption may further include: after the transmission of the express frame is completed, setting a second custom preamble including the frame length information; and transmitting a preemptable packet by adding the second custom preamble to the payload of the remaining fragmented preamble frame through the MAC layer.

The method for providing a frame preemption may further include: when the frame to be transmitted is an express frame, setting a third custom preamble including an express frame delimiter; and transmitting an express packet by adding the third custom preamble to the payload of the express frame through the MAC layer.

According to another embodiment, a method for providing a frame preemption in a receiving apparatus is provided. The method for providing a frame preemption includes: checking a custom preamble of the frame received through a media access control (MAC) layer; and when the received frame is a preemptable frame, determining whether the preemptable frame is fragmented using frame length information set in the custom preamble of the preemptable frame.

The determining of whether the preemptable frame is fragmented may include: comparing the frame length information with an accumulated size of the accumulated preemptable frame; and determining that the received preemptable frame is fragmented when the accumulated size is smaller than the frame length information.

The determining of whether the preemptable frame is fragmented may further include: storing the received preemptable frame; and updating the accumulated size by accumulating a size of the received preemptable frame when the received preamble frame is fragmented.

The determining of whether the preemptable frame is fragmented further may further include transferring the received preemptable frame to a preemptable frame reception queue when the accumulated size is the same as frame length information set in the custom preamble of the received preemptable frame.

The transferring of the received preemptable frame may include: when a previously received fragmented preemptable frame is stored, reassembling the previously received fragmented preamble frame with the received preemptable frame; and storing the reassembled frame in the preemptable frame reception queue.

The method for providing a frame preemption may further include checking validity of the preemptable frame using the number of the preemptable frame set in the custom preamble and a fragment count of the preemptable frame before the determining.

According to another embodiment, an apparatus for providing a frame preemption in a receiving apparatus is provided. The apparatus for providing a frame preemption frame includes: a frame classifier that classifies a frame received through a media access control (MAC) layer into an express frame or a preemptable frame; and a preemption processor determines, when the received frame is a preemptable frame, whether the preemptable frame is fragmented by using frame length information set in a custom preamble of the preemptable frame.

The preemption processor may determine that the received preemptable frame is fragmented when an accumulated size of the accumulated preemptable frame is smaller than the frame length information, may store the received preemptable frame, and may update the accumulated size by accumulating a size of the received preemptable frame.

The preemption processor may transfer the received preemptable frame to a preemptable frame reception queue when the accumulated size is the same as frame length information set in the custom preamble of the received preemptable frame.

When a previously received fragmented preemptable frame is stored, the preemption processor may reassemble the previously received fragmented preamble frame with the received preemptable frame, and may transfer the reassembled frame.

The apparatus for providing a frame preemption may further include a custom preamble checker that checks validity of the preemptable frame by using the number of the preemptable frame set in the custom preamble and the fragment count of the preemptable frame.

### BRIEF DESCRIPTION OF THE DRAWINGS

FIG. 1 is a diagram for explaining a conventional frame preemption.

FIG. 2 is a diagram illustrating a transmitting apparatus and a receiving apparatus including a frame preemption function according to an embodiment.

FIG. 3 is a flowchart illustrating a method for processing preemption transmission in the frame preemption transmission processor shown in FIG. 2.

FIG. 4 is a flowchart illustrating a method for processing preemption reception in the frame preemption reception processor shown in FIG. 2.

FIG. 5 is a diagram illustrating an example of an Ethernet packet configuration for a case in which an express frame is transmitted by a frame preemption transmission processor according to an embodiment.

FIG. 6 is a diagram illustrating an example of an Ethernet packet configuration for a case in which a frame preemption transmission processor transmits a preemptable frame without a frame preemption procedure according to an embodiment.

FIG. 7 is a diagram illustrating an example of the configuration of an Ethernet packet for a case in which the frame preemption transmission processor transmits a preemptable frame through a frame preemption procedure according to an embodiment.

FIG. 8 is a diagram illustrating an apparatus for providing frame preemption according to an embodiment.

FIG. 9 is a diagram illustrating an apparatus for providing frame preemption according to another embodiment.

FIG. 10 is a diagram illustrating an apparatus for providing frame preemption according to another embodiment.

### DETAILED DESCRIPTION OF THE EMBODIMENTS

Hereinafter, embodiments of the present invention will be described in detail with reference to the attached drawings so that a person of ordinary skill in the art may easily implement the present invention. The present invention may be modified in various ways, and is not limited thereto. In the drawings, elements that are irrelevant to the description of the present invention are omitted for clarity of explanation, and like reference numerals designate like elements throughout the specification.

Throughout the specification and claims, when a part is referred to “include” a certain element, it means that it may further include other elements rather than exclude other elements, unless specifically indicated otherwise.

Hereinafter, a method and apparatus for providing frame preemption according to an embodiment will be described in detail with reference to the drawings.

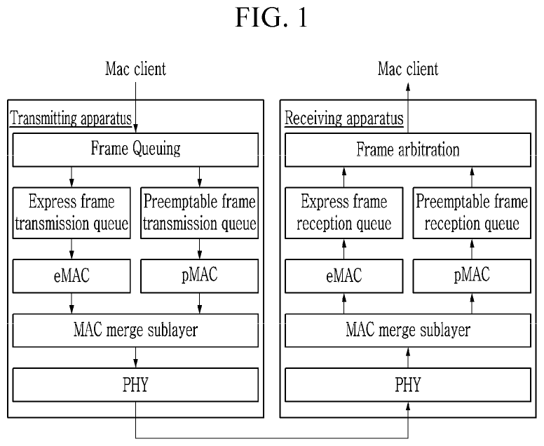

FIG. 1 is a diagram for explaining a conventional frame preemption.

Referring to FIG. 1, a frame preemption in a transmitting apparatus and a receiving apparatus is implemented using an express media access control (eMAC) for express frames, a preemptable MAC (pMAC) for preamble frames, and a MAC merge sublayer

The MAC merge sublayer defines and uses a MAC merge packet (hereinafter, referred to as an mPacket).

The mPacket is divided into an express packet, a complete preemptable packet, and a fragmented preemptable packet. The express packet is used to transmit high-priority frames. The complete preemptable packet is used for transmission of a low-priority frame without a fragmentation process. The fragmented preamble packet has a low priority and is used for transmission of fragmented frames.

The mPacket can be divided into an express packet including an SMD-Express (SMD-E) and a preemptable packet including an SMD-Start preemptable (SMD-S) or an SMD-Continue preemptable (SMD-C), according to the SMD (Start mPacket Delimiter) value. Complete preamble packet and first, intermediate, and last fragmented preemptable packets can be distinguished by SMD-S, SMD-C, fragment count (FRAG_COUNT), and mPacket Cyclic Redundancy Check (mCRC).

As such, in the conventional frame preemption scheme using the MAC merge sublayer, a MAC merge sublayer must be added between a general MAC and a reconciliation sublayer (RS), and a plurality of MACs divided into eMAC and pMAC must be used. In addition, since packet fragmentation is performed in the MAC merge sublayer after MAC when transmitting a packet by a transmitting apparatus, mCRC calculation for updating the frame check sequence (FCS) field needs to be re-performed, and mCRC calculation must be additionally performed in order to detect the fragmented packet in the MAC merge sublayer before MAC when receiving the packet by a receiving apparatus.

In an embodiment, the frame preemption function can be performed without using a plurality of MACs as in the conventional frame preemption scheme, and a frame preemption method having a simple structure capable of detecting a fragmented preamble packet without relying on the calculation of mCRC is provided.

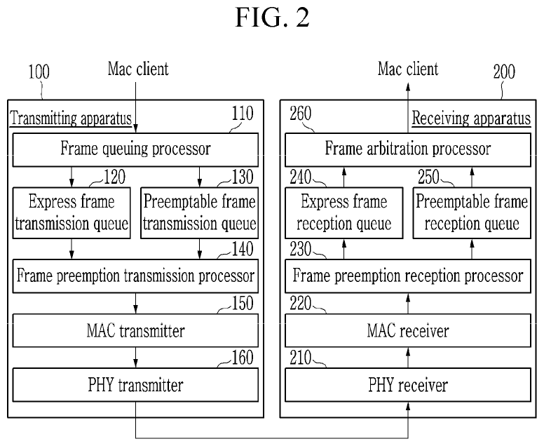

FIG. 2 is a diagram illustrating a transmitting apparatus and a receiving apparatus including a frame preemption function according to an embodiment.

Referring to FIG. 2, the transmitting apparatus 100 includes a frame queuing processor 110, an express frame transmission queue 120, a preemptable frame transmission queue 130, a frame preemption transmission processor 140, a MAC transmitter 150, and a PHY transmitter 160.

The frame queuing processor 110 divides the frame received from the MAC client into an express frame and a preemptable frame, transfers the express frame to the express frame transmission queue 120, and transfers the preemptable frame to the preemptable frame transmission queue 130. The express frame and preamble frame can be distinguished based on 8-level traffic classes, and frames of a higher-priority traffic class are classified as an express frame and delivered to the express frame transmission queue 120, while frames of the remaining traffic classes are classified as a preemptable frame and transferred to the preemptable frame transmission queue 130.

The express frame transmission queue 120 stores the express frame transmitted from the frame queuing processing unit 110, and transfers the stored express frame to the frame preemption transmission processor 140.

The preemptable frame transmission queue 130 stores the preemptable frame transmitted from the frame queuing processor 110, and transfers the stored preemptable frame to the frame preemption transmission processor 140.

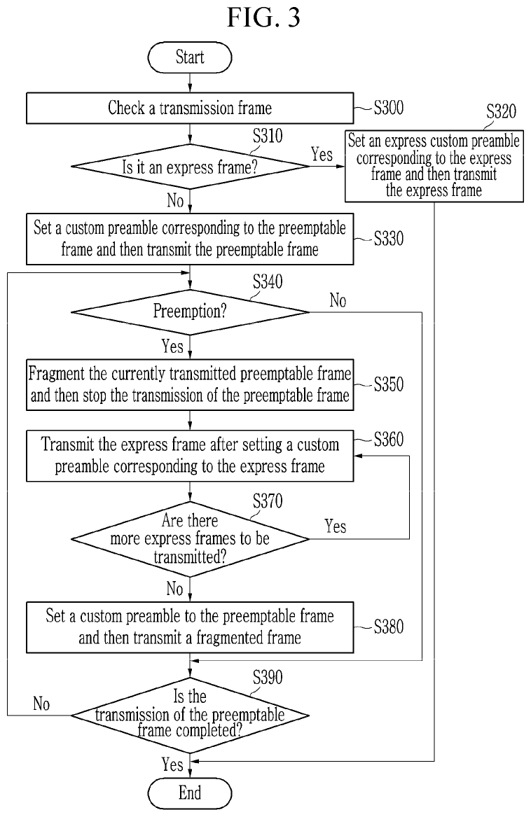

In order to minimize the transmission delay of the express frame for each frame transmitted from the express frame transmission queue 120 and the preamble frame transmission queue 130, respectively, the frame preemption transmission processor 140 stops the transmission of the preamble packet and performs the function for transmitting the express packet even when the preemptable packet is already being transmitted on the link. The frame preemption transmission processing of the frame preemption transmission processor 140 will be described in detail with reference to FIG. 3.

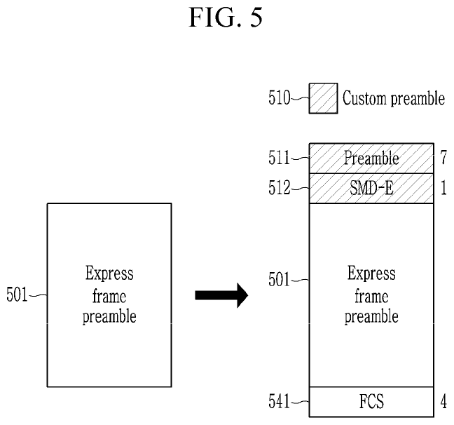

The MAC transmitter 150 adds an 8-byte custom preamble and an FCS field to the express frame and the preemptable frame transmitted through the frame preemption transmission processor 140 for packetizing. At this time, the 8-byte custom preamble is set according to the type of the frame transmitted from the frame preemption transmission processor 140 and whether fragmentation is performed, and the custom preamble will be described in detail based on FIG. 5.

The PHY transmitter 160 transmits the express packet and the preemptable packet transmitted from the MAC transmitter 150 through the link.

The transmitted express packet and preemptable packet are received by the receiving apparatus 200 through a link.

The receiving apparatus 200 includes a PHY receiver 210, a MAC receiver 220, a frame preemption reception processor 230, an express frame reception queue 240, a preemptable frame reception queue 250, and a frame arbitration processor 260.

The express packet and the preemptable packet received through the link are transmitted to the MAC receiver 220 through the PHY receiver 210.

The MAC receiver 220 performs a CRC check on the received express packet and the preemptable packet, extracts the custom preamble added by the MAC transmitter 150 of the transmitting apparatus 100, and then delivers the express frame and the preemptable frame to the frame preemption reception processor 230.

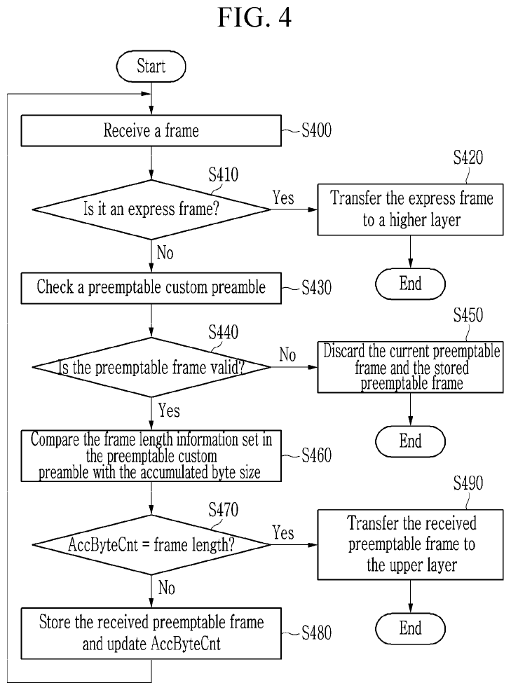

The frame preemption reception processor 230 transfers the express frame to the express frame reception queue 240. In the case of the preemptable frame, the frame preemption reception processor 230 determines whether the preemptable frame is fragmented, performs a reassembly process if necessary, and then transfers the preemptable frame to the preemptable frame reception queue 250. The frame preemption reception processor 230 will be described in more detail with reference to FIG. 4.

Express frames and preemptable frames stored in the express frame reception queue 240 and the preemptable frame reception queue 250 are transmitted to the MAC client through the frame arbitration processor 260.

The frame arbitration processor 260 may process the frame so that the express frame is transmitted before the preemptable frame by giving priority to the express frame on a frame-by-frame basis in the process of transmitting the express frame and the preemptable frame to the MAC client.

FIG. 3 is a flowchart illustrating a method for processing preemption transmission in the frame preemption transmission processor shown in FIG. 2.

Referring to FIG. 3, the frame preemption transmission processor 140 checks a transmission frame (S300). In this step S300, the frame preemption transmission processor 140 checks whether there is a transmission frame.

If there is a transmission frame, the frame preemption transmission processor 140 determines whether the transmission frame is an express frame by checking the type of the transmission frame (S310).

When the transmission frame is an express frame, the frame preemption transmission processor 140 sets an 8-byte express custom preamble corresponding to the express frame and then transmits the frame (S320).

When the transmission frame is not an express frame, that is, if it is a preamble frame, the frame preemption transmission processor 140 sets an 8-byte custom preamble corresponding to the preemptable frame and then transmits the frame (S330).

Once the transmission of the preemptable frame is started, the frame preemption transmission processor 140 always checks whether preemption is performed until the transmission of the preemptable frame is completed (S340).

In the step S340 of checking whether the preemption is performed, when the preemption condition is satisfied due to the transmission request of the express frame and the preemption is determined, the frame preemption transmission processor 140 fragments the currently transmitted preemptable frame and then stops the transmission of the preemptable frame (S350), and transmits the express frame after setting a custom preamble of 8 bytes corresponding to the express frame (S360). In the step S340 of checking whether preemption is performed, the case of the preemption condition is satisfied, and includes the case of the basic setting for performing preemption being satisfied and the Ethernet minimum frame size (64 bytes) being satisfied even if the fragmentation process of the preemptable frame that is already being transmitted is performed when there is a transmission request of the express packet during transmission of a preemptable frame, as specified in the IEEE802.3br standard.

When the transmission of the express frame is finished, the frame preemption transmission processor 140 checks whether there are additional packets to be transmitted (S370).

When there are more express frames to be transmitted, the frame preemption transmission processor 140 sets a custom preamble of 8 bytes corresponding to the express frame and transmits the express frame (S360).

Meanwhile, if there is no express frame to be transmitted, the frame preemption transmission processor 140 sets a custom preamble of 8 bytes corresponding to the preemptable frame for transmission of the remaining fragmented preemptable frame in step S350, and transmits the fragmented frame (S380).

Next, the frame preemption transmission processor 140 checks whether the transmission of the preemptable frame is complete (S390), and repeats steps S340 to S390 until the end of the preamble frame (End of Frame) to complete the transmission of the preemptable frame.

FIG. 4 is a flowchart illustrating a method for processing preemption reception in the frame preemption reception processor shown in FIG. 2.

Referring to FIG. 4, the frame preemption reception processor 230 receives a frame (S400), and checks whether the received frame is an express frame (S410). The frame preemption reception processor 230 checks the custom preamble of the received frame and determines that the frame is an express frame if the custom preamble of the received frame is an express custom preamble corresponding to an express frame.

When the received frame is an express frame, the frame preemption reception processor 230 transfers the corresponding express frame to a higher layer (S420).

When the custom preamble of the received frame is a preemptable custom preamble corresponding to the preemptable frame, the frame preemption reception processor 230 checks the corresponding preemptable custom preamble (S430).

The frame preemption reception processor 230 checks the validity of the preemptable frame after checking the preemptable custom preamble (S440). The frame preemption reception processor 230 may check validity of the preemptable frame by checking whether the number SMD-S or SMD-C of the preemptable frame set in the preemptable custom preamble and the fragment count FRAG_COUNT of the preemptable frame match a predetermined rule.

The frame preemption reception processor 230 discards the current preemptable frame including the stored preemptable frame (S450) when the number SMD-S or SMD-C of the preemptable frame set in the preemptable custom preamble and the fragment count FRAG_COUNT of the preemptable frame do not match the predetermined rule.

On the other hand, the frame preemption reception processor 230 compares the frame length information set in the preemptable custom preamble with the accumulated byte size of the preemptable frame (S460) when the number SMD-S or SMD-C of the preemptable frame set in the preemptable custom preamble and the fragment count FRAG_COUNT of the preemptable frame match the predetermined rule. The frame preemption reception processor 230 compares the frame length information set in the preemptable custom preamble of the preemptable frame with the accumulated byte size AccByteCnt of the preemptable frame, in order to distinguish whether the currently received preamble frame is a fragmented frame or a complete frame without fragmentation.

When the accumulated byte size AccByteCnt of the preemptable frame is less than the frame length information set in the preemptable custom preamble of the received preemptable frame (S470), the frame preemption reception processor 230 determines that not all fragmented frames of the preemptable frame have been received, stores the received preemptable frame, and accumulates and updates the accumulated byte size AccByteCnt of the preemptable frame until all the fragmented frames of the preemptable frame are received (S480). The step S480 is a process of determining that the preemptable frame is fragmented and then transmitted by the frame preemption transmission processor 140 of the transmitting apparatus 100, storing the received preemptable frame, and accumulating and updating accumulated byte size AccByteCnt of the received preemptable frame until all the fragmented frames of the preemptable frame are completely received.

The frame preemption reception processor 230 repeats steps S400 to S480 until the accumulated byte size AccByteCnt of the preemptable frame is equal to the frame length information of the preemptable frame.

If the accumulated byte size AccByteCnt of the preemptable frame is the same as the frame length information of the preemptable frame set in the preemptable custom preamble of the received preemptable frame (S470), the frame preemption reception processor 230 transfers the received preemptable frame to the upper layer (S490). At this time, if the previously received fragmented preemptable frame is stored, that is, if the previous preemptable frame is received and stored in a fragmented state, and the last fragmented preemptable frame is currently received, the frame preemption reception processor 230 performs a reassembly process of the stored preemptable frame and the last received preamble preemptable frame, and then may transfer it to a higher layer. If the previously received fragmented preemptable frame is not stored, that is, if the preemptable frame is not fragmented, it is directly transferred to a higher layer without a reassembly process.

FIG. 5 is a diagram illustrating an example of an Ethernet packet configuration for a case in which an express frame is transmitted by a frame preemption transmission processor according to an embodiment.

Referring to FIG. 5, the frame preemption transmission processor 140 sets an express custom preamble when a frame to be transmitted is an express frame.

The express custom preamble 510 of the express frame has the same shape as the preamble of a general Ethernet packet.

The express custom preamble 510 has a form in which a preamble 511 of 7 bytes and an SMD-E 512 of 1 byte are connected, as defined in the IEEE802.3br standard. Each byte in the preamble 511 of 7 bytes has a value of 0x05, and the 1 byte in the SMD-E 512 has a value of 0xD5.

The SMD-E 512 is used as a delimiter of an express frame in the frame preemption reception processor 230 of the receiving apparatus 200.

The express frame payload 501 is packetized into an express packet by adding a custom preamble 510 of the express frame and the FCS 541 according to the express frame payload 501 in the MAC transmitter 150 of the transmitting apparatus 100. Next, the express packet is transmitted to the link through the PHY transmitter 160.

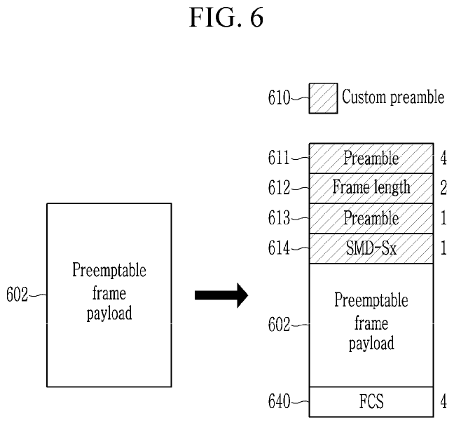

FIG. 6 is a diagram illustrating an example of an Ethernet packet configuration for a case in which a frame preemption transmission processor transmits a preemptable frame without a frame preemption procedure according to an embodiment.

Referring to FIG. 6, if there is no frame preemption request as a result of checking whether preemption is performed in step S340 of FIG. 3, the frame preemption transmission processor 140 does not perform the fragmentation process of the preamble frame. In this case, the custom preamble 610 of the preemptable frame includes a preamble 611 of 4 bytes, frame length information 612 of 2 bytes, a preamble 613 of 1 byte, and SMD-Sx 614 of 1 byte.

The preamble 611 of 4 bytes has the same configuration as the upper 4 bytes of the preamble of the existing Ethernet packet, and each byte has a value of 0x05. The frame length information 612 of 2 bytes is used to determine whether the received frame is fragmented by the frame preemption reception processor 230 of the receiving apparatus 200, and represents the length of the entire frame before fragmentation in bytes. The preamble 613 of 1 byte has a value of 0x05 like the preamble of the existing Ethernet packet. The SMD-Sx 614 of the last 1 byte has the same configuration as the SMD-Sx defined in the IEEE802.3br standard.

The SMD-Sx 614 is used as a delimiter of the preemptable frame in the frame preemption reception processor 230 of the receiving apparatus 200, and when it is not received in a predetermined order as in the IEEE802.1br standard, it is used as an indicator to discard the preamble frame in step S450.

The frame length information 612 makes it possible to distinguish whether the preemptable frame received by the frame preemption reception processor 230 is in a fragmented state or in a complete state that does not undergo a fragmentation process.

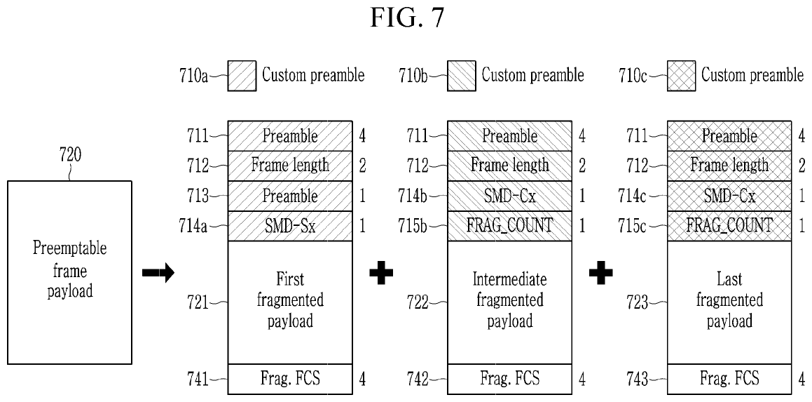

When the accumulated byte size AccByteCnt of the received preemptable frame is equal to the frame length information 612, the frame preemption reception processor 230 determines that the reception of the preemptable frame is completed. If the accumulated byte size AccByteCnt is smaller than the frame length information 612, it is determined that the transmitting apparatus 100 has performed the fragmentation process and the step S280 described with reference to FIG. 4 is performed. The fragmentation process of the preemptable frame will be described in detail with reference to FIG. 7.

The preemptable frame payload 602 transmitted without performing frame preemption is packetized into an preemptable packet by adding a preemptable custom preamble 610 of the preemptable frame and the FCS 641 according to the preemptable frame payload 602 in the MAC transmitter 150 of the transmitting apparatus 100. Next, the preemptable packet is transmitted to the link through the PHY transmitter 160.

FIG. 7 is a diagram illustrating an example of the configuration of an Ethernet packet for a case in which the frame preemption transmission processor transmits a preemptable frame through a frame preemption procedure according to an embodiment.

Referring to FIG. 7, for convenience of explanation, it will be described that the preemptable frame payload 720 is packetized into an Ethernet packet including the first fragmented payload 721, an Ethernet packet including the intermediate fragmented payload 722 existing between the first and last fragmented payloads, and an Ethernet packet including the last fragmented payload 723.

When the preemptable frame is transmitted through the frame preemption procedure, the custom preamble 710a of the preemptable packet including the first fragmented payload 721 may be composed of a preamble 711 of 4 bytes and frame length information 712 of 2 bytes, a preamble 713 of 1 byte, and an SMD-Sx 714a of 1 byte.

The preamble 711 of 4 byte has the same configuration as the upper 4 bytes of the preamble of the existing Ethernet packet, and each byte has a value of 0x05. The frame length information 712 of 2 bytes is used to determine whether the received frame is fragmented by the frame preemption reception processor 230 of the receiving apparatus 200, and represents the length of the entire frame before fragmentation in bytes. The preamble 713 of 1 byte has a value of 0x05 like the preamble of the existing Ethernet packet. The SMD-Sx 714a of the last 1 byte has the same configuration as the SMD-Sx defined in the IEEE802.3br standard.

The SMD-Sx 714a is used as a delimiter of the preemptable frame in the frame preemption reception processor 230 of the receiving apparatus 200, and when it is not received in a predetermined order, it is used as an indicator to discard the preamble frame in step S450, as in the IEEE802.1br standard.

The frame length information 712 makes it possible to distinguish whether the preemptable frame received by the frame preemption reception processor 230 is in a fragmented state or in a complete state that does not undergo a fragmentation process. When the accumulated byte size AccByteCnt of the received preemptable frame is equal to the frame length information 712, the frame preemption reception processor 230 determines that the reception of the preemptable frame is completed. If the accumulated byte size AccByteCnt is smaller than the frame length information 712, the frame preemption reception processor 230 determines that the transmitting apparatus 100 has performed the fragmentation process and waits for reception of the next fragmented preemptable frame.

The preemptable frame payload 720 that has passed the frame preemption procedure is packetized into a preemptable packet by adding the preemptable custom preamble 710a and the FCS 741 according to the first fragmented preemptable frame payload 721 to the first fragmented preemptable frame payload 721 in the MAC transmitter 150 of the transmitting apparatus 100. Next, the preemptable packet is transmitted to the link through the PHY transmitter 160.

The custom preamble 710b of the Ethernet packet including the intermediate fragmented payload 722 includes a preamble 711 of 4 bytes, frame length information 712 of 2 bytes, SMD-Cx 714b of 1 byte, and a fragment count FRAG_COUNT 715b of 1 byte.

The preamble 711 of 4 bytes and the frame length information 712 of 2 bytes have the same value as the first fragmented preemptable packet. The subsequent SMC-Cx 714b and fragment count FRAG_COUNT 715b have the same configuration as SMD-Cx and FRAG_COUNT defined in the IEEE802.3br standard.

The SMD-Cx 714b is used as a delimiter of the preemptable frame received by the frame preemption reception processor 230 of the receiving apparatus 200, and when it is not received in a predetermined order, it is used as an indicator to discard the preamble frame in step S450, as in the IEEE802.1br standard, by interworking with the fragment count FRAG_COUNT 715b.

The fragment count FRAG_COUNT 715b is used as an indicator for classifying the reception order of the fragmented preemptable frame in the frame preemption reception processor 230 of the reception apparatus 200, and it is used as an indicator to discard the preamble frame in step S450, as in the IEEE802.1br standard, by interworking with the SMD-Cx 714b.

The frame length information 712 enables the frame preemption reception processor 230 of the receiving apparatus 200 to distinguish whether the received preemptable frame is in a fragmented state or in a complete state that does not undergo a fragmentation process. When the accumulated byte size AccByteCnt of the received preemptable frame is smaller than the frame length information 712, the frame preemption reception processor determines that there is a next fragmented preemptable frame and waits for reception of the next fragmented preemptable frame.

As described above, the preemptable frame payload 720 that has passed the frame preemption procedure is packetized into a preemptable packet by adding the preemptable custom preamble 710b and the FCS 742 according to the intermediate fragmented payload 722 to the intermediate fragmented payload 722 in the MAC transmitter 150 of the transmitting apparatus 100. Next, the preemptable packet is transmitted to the link through the PHY transmitter 160.

The custom preamble 710c of the Ethernet packet including the last fragmented payload 723 includes a preamble 711 of 4 bytes, frame length information 712 of 2 bytes, SMD-Cx 714c of 1 byte, and a fragment count FRAG_COUNT 715c of 1 byte.

The preamble 711, frame length information 712, and SMC-Cx 714c have the same value as the intermediate fragmented preamble packet. The subsequent fragment count FRAG_COUNT 715c has the same configuration as FRAG_COUNT defined in the IEEE802.3br standard.

The fragment count FRAG_COUNT 715c is used as an indicator for classifying the reception order of the fragmented preemptable frame in the frame preemption reception processor 230 of the reception apparatus 200, and it is used as an indicator to discard the preamble frame in step S450, as in the IEEE802.1br standard, by interworking with the SMD-Cx 714c.

The frame length information 712 enables the frame preemption reception processor 230 of the receiving apparatus 200 to distinguish whether the received preemptable frame is in a fragmented state or in a complete state that does not undergo a fragmentation process. When the accumulated byte size AccByteCnt of the received preemptable frame is equal to the frame length information 712, the frame preemption reception processor 230 determines that the reception of the entire preemptable frame is completed and performs a reassembly process of the corresponding preemptable frame.

In this way, the preemptable frame payload 720 that has passed the frame preemption procedure is packetized into a preemptable packet by adding the preemptable custom preamble 710c and the FCS 743 according to the last fragmented preemptable payload 723 to the last fragmented preemptable payload 721 in the MAC transmitter 150 of the transmitting apparatus 100. Next, the preamble packet is transmitted to the link through the PHY transmitter 160.

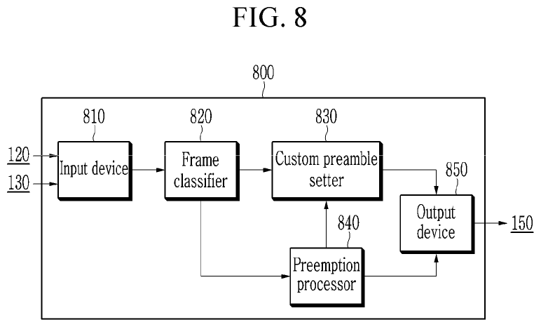

FIG. 8 is a diagram illustrating an apparatus for providing frame preemption according to an embodiment.

Referring to FIG. 8, the apparatus for providing frame preemption 800 may refer to the frame preemption transmission processor 140 of the transmitting apparatus 100 illustrated in FIG. 2. The apparatus for providing frame preemption 800 includes an input device 810, a frame classifier 820, a custom preamble setter 830, a preemption processor 840, and an output device 850.

The transmission frame is transmitted to the frame classifier 820 through the input device 810.

The frame classifier 820 determines whether the transmission frame is an express frame or a preemptable frame and transmits the express frame, and transmits the preemptable frame to the custom preamble setter 830.

The custom preamble setter 830 sets the express custom preamble of 8 bytes in the express frame and sets the preemptable custom preamble in the preemptable frame. The express custom preamble is set as described with reference to FIG. 5. The preemptable custom preamble is set as described with reference to FIG. 6 or 7 according to whether preemption is performed.

The preemption processor 840 determines whether to perform preemption after transmission of the preamble frame is started. If the preemption processor 840 determines the preemption due to the request for transmission of the express frame during transmission of the preemptable frame, the preemption processor 840 fragments the currently transmitted preemptable frame and then stops the transmission of the preemptable frame. When the transmission of the express frame is completed, the preemption processor 840 may resume transmission of the preemptable frame that has been stopped.

The output device 850 transmits the express frame included the express custom preamble to the MAC transmitter 150, and transmits the preemptable frame included the preemptable custom preamble to the MAC transmitter 150.

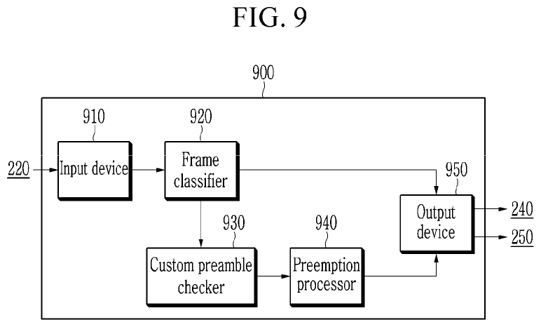

FIG. 9 is a diagram illustrating an apparatus for providing frame preemption according to another embodiment.

Referring to FIG. 9, the apparatus for providing frame preemption 900 may refer to the frame preemption receiving processor 230 of the receiving apparatus 200 illustrated in FIG. 2. The apparatus for providing frame preemption 900 includes an input device 910, a frame classifier 920, a custom preamble checker 930, a preemption processor 940, and an output device 950.

The received frame passing through the MAC receiver 220 is transmitted to the frame classifier 920 through the input device 910.

The frame classifier 920 determines whether the transmission frame is an express frame or a preemptable frame, transmits the express frame to the output device 950, and transmits the preemptable frame to the custom preamble checker 930.

The custom preamble checker 930 extracts the preemptable custom preamble from the preemptable frame, and checks validity of the preemptable frame using the number SMD-S or SMD-C of the preemptable frame set in the preemptable custom preamble and the frame fragment count FRAG_COUNT of the preemptable frame.

The preemption processor 940 checks whether the currently received valid preemptable frame is a fragmented frame or a complete frame that does not undergo a fragmentation process. The preemption processor 940 compares the accumulated byte size AccByteCnt of the preemptable frame with the frame length information of the preemptable frame set in the preemptable custom preamble of the received preemptable frame, and may determine whether the received preemptable frame is a fragmented frame or a complete frame. The preemption processor 940 transmits the complete preemptable frame to the output device 950, and if the currently received transmit frame is a fragmented frame, stores the currently received fragmented transmit frame, and accumulates and updates the frame byte size. In this way, when the last fragmented preemptable frame is received, the preemption processor 940 reassembles the stored fragmented preemptable frame and the last received fragmented preemptable frame to generate a preemptable frame and then transmits the generated preemptable frame to the output device 950.

The output device 950 transfers the express frame to the express frame reception queue 240, and transfers the preamble frame to the preemptable frame reception queue 250.

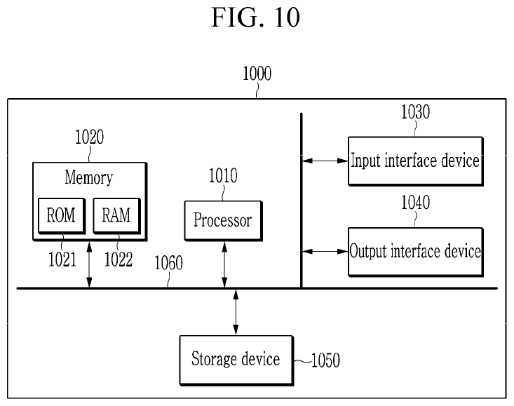

FIG. 10 is a diagram illustrating an apparatus for providing frame preemption according to another embodiment.

Referring to FIG. 10, the apparatus for providing frame preemption 1000 may represent a computing device in which the method for processing a frame preemption transmission of the frame preemption transmission processor or the method for processing a frame preemption reception of the frame preemption reception processor 230 according to the embodiment described above is implemented.

The apparatus for providing frame preemption 1000 may include at least one of a processor 1010, a memory 1020, an input interface device 1030, an output interface device 1040, and a storage device 1050. Each of the components may be connected by a common bus 1060 to communicate with each other. In addition, each of the components may be connected through an individual interface or an individual bus centered on the processor 1010 instead of the common bus 1060.

The processor 1010 may be implemented as various types such as an application processor (AP), a central processing unit (CPU), a graphics processing unit (GPU), etc., and may be any semiconductor device that executes a command stored in the memory 1020 or the storage device 1050. The processor 1010 may execute a program command stored in at least one of the memory 1020 and the storage device 1050.

The processor 1010 may be configured to implement the method for processing frame preemption transmission described above based on FIGS. 2, 3, and 5 to 8. For example, the processor 1010 may load program commands for implementing at least some functions of the input device 810, the frame classifier 820, the custom preamble setter 830, the preemption processor 840, and the output device 850 described in FIG. 8 to the memory 1020, and may perform the operation described with reference to FIGS. 2, 3, and 5 to 8. The processor 1010 may be configured to implement the method for processing frame preemption reception described above based on FIGS. 2, 4, 5 to 7, and 9. For example, the processor 1010 may load program commands for implementing at least some functions of the input device 910, the frame classifier 920, the custom preamble checker 930, the preemption processor 940, and the output device 950 described in FIG. 9 to the memory 1020, and may perform the operation described with reference to FIGS. 2, 4, 5 to 7, and 9.

The memory 1020 and the storage device 1050 may include various types of volatile or non-volatile storage media. For example, the memory 1020 may include a read-only memory (ROM) 1021 and a random access memory (RAM) 1022. In an embodiment, the memory 1020 may be located inside or outside the processor 1010, and the memory 1020 may be connected to the processor 1010 through various known means.

The input interface device 1030 is configured to provide data (e.g., an express frame or a preemptable frame) to the processor 1010, and the output interface device 1040 is configured to provide data (e.g., an express frame or a preemptable frame) from the processor 1010.

In addition, at least some of the method for processing frame preemption transmission/reception according to an embodiment may be implemented as a program or software executed in a computing device, and the program or software may be stored in a computer-readable medium.

In addition, at least some of the method for processing frame preemption transmission/reception according to the embodiment may be implemented as hardware that can be electrically connected to the computing device.

According to an embodiment, since a frame preemption process is performed in an upper layer of the MAC, a frame preemption function may be provided by using a single MAC without using a plurality of MACs including the conventional eMAC and pMAC for frame preemption. In addition, it is possible to provide a frame preemption having a simple structure by detecting whether a fragmented preemptable packet is received through comparing the length information of the frame included in the custom preamble without relying on CRC calculation.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing, or to control an operation of a data processing apparatus, e.g., by a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk and a read only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit. The processor may run an operating system (08) and one or more software applications that run on the OS. The processor device also may access, store, manipulate, process, and create data in response to execution of the software. For purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products. It should be understood that the embodiments disclosed herein are merely illustrative and are not intended to limit the scope of the invention. It will be apparent to one of ordinary skill in the art that various modifications of the embodiments may be made without departing from the spirit and scope of the claims and their equivalents.

What is claimed is:

1. A method for providing a frame preemption in a transmitting apparatus, the method comprising:
when a frame to be transmitted is a preemptable frame, setting a first custom preamble including frame length information for a payload of the preemptable frame; and
transmitting a preemptable packet by adding the first custom preamble to the payload of the preemptable frame through a media access control (MAC) layer.

2. The method of claim 1, wherein the frame length information is used to distinguish whether the preemptable frame received by a receiving apparatus is in a fragmented state by the frame preemption of the transmitting apparatus.

3. The method of claim 1, further comprising fragmenting the preemptable frame being transmitted and then stopping transmission of the preemptable frame if preemption is determined by the request for transmission of the express frame before the transmission of the preemptable frame is completed.

4. The method of claim 3, further comprising:
after the transmission of the express frame is completed, setting a second custom preamble including the frame length information; and
transmitting a preemptable packet by adding the second custom preamble to the payload of the remaining fragmented preamble frame through the MAC layer.

5. The method of claim 1, further comprising:
when the frame to be transmitted is an express frame, setting a third custom preamble including an express frame delimiter; and
transmitting an express packet by adding the third custom preamble to the payload of the express frame through the MAC layer.

6. A method for providing a frame preemption in a receiving apparatus, the method comprising:
checking a custom preamble of the frame received through a media access control (MAC) layer; and
when the received frame is a preemptable frame, determining whether the preemptable frame is fragmented using frame length information set in the custom preamble of the preemptable frame.

7. The method of claim 6, wherein
the determining of whether the preemptable frame is fragmented includes:
comparing the frame length information with an accumulated size of the accumulated preemptable frame; and
determining that the received preemptable frame is fragmented when the accumulated size is smaller than the frame length information.

8. The method of claim 7, wherein the determining of whether the preemptable frame is fragmented further includes storing the received preemptable frame, and updating the accumulated size by accumulating size of the received preemptable frame, when the received preamble frame is fragmented.

9. The method of claim 7, wherein the determining of whether the preemptable frame is fragmented further includes transferring the received preemptable frame to a preemptable frame reception queue, when the accumulated size is the same as frame length information set in the custom preamble of the received preemptable frame.

10. The method of claim 9, wherein the transferring of the received preemptable frame includes:
when a previously received fragmented preemptable frame is stored, reassembling the previously received fragmented preamble frame with the received preemptable frame; and
storing the reassembled frame in the preemptable frame reception queue.

11. The method of claim 6, further comprising checking validity of the preemptable frame using the number of the preemptable frame set in the custom preamble and a fragment count of the preemptable frame before the determining.

12. An apparatus for providing a frame preemption in a receiving apparatus, the apparatus comprising:
a frame classifier classifies a frame received through a media access control (MAC) layer into an express frame or a preemptable frame; and
a preemption processor that determines, when the received frame is a preemptable frame, whether the preemptable frame is fragmented by using frame length information set in a custom preamble of the preemptable frame.

13. The apparatus of claim 12, wherein the preemption processor determines that the received preemptable frame is fragmented when an accumulated size of the accumulated preemptable frame is smaller than the frame length information, stores the received preemptable frame, and updates the accumulated size by accumulating size of the received preemptable frame.

14. The apparatus of claim 12, wherein the preemption processor transfers the received preemptable frame to a preemptable frame reception queue, when the accumulated size is the same as frame length information set in the custom preamble of the received preemptable frame.

15. The apparatus of claim 14, wherein when a previously received fragmented preemptable frame is stored, the preemption processor reassembles the previously received fragmented preamble frame with the received preemptable frame, and transfers the reassembled frame.

16. The apparatus of claim 12, further comprising a custom preamble checker that checks validity of the preemptable frame by using the number of the preemptable frame set in the custom preamble and the fragment count of the preemptable frame.
